(19) United States
(12) Patent Application Publication
(10) Pub. No.: US 2022/0164459 A1
(43) Pub. Date: May 26, 2022

(54) SYSTEMS AND METHODS FOR EVALUATING CONSENT MANAGEMENT

(71) Applicant: Ad Lightning Inc., Seattle, WA (US)

(72) Inventors: Drake Callahan, Seattle, WA (US); Doug Britsch, Seattle, WA (US)

(21) Appl. No.: 17/455,857

(22) Filed: Nov. 19, 2021

Related U.S. Application Data
(60) Provisional application No. 63/198,910, filed on Nov. 20, 2020.

(51) Int. Cl. G06F 21/60

(52) U.S. Cl. CPC G06F 21/604

(57) ABSTRACT

In some embodiments, a method for evaluating consent management includes generating a synthetic-user profile including a consent property indicating an opt-out status with respect to tracking user behavior for one or more target websites. The synthetic-user profile is exposed to one or more third-party websites such that dynamic content of the third-party websites is received by the synthetic-user profile. Data is retrieved that corresponds to the dynamic content of the one or more third-party websites. Based on the retrieved data, the consent management with respect to the target website is evaluated.

### CROSS-REFERENCE TO RELATED APPLICATIONS

This application claims priority to U.S. Provisional Application No. 63/198,910, filed Nov. 20, 2020, which is hereby incorporated by reference in its entirety. Additionally, the disclosures of U.S. Patent Application Nos. 62/938,723, 15/439,475, 15/439,351, and 16/402,878 are herein incorporated by reference in their entireties.

### TECHNICAL FIELD

The present technology relates to systems and methods for evaluating consent management related to online content.

### BACKGROUND

In many jurisdictions around the world, statutes and regulations require that user consent be obtained before tracking the user's online behavior. Current examples include the European Union's General Data Protection Regulation (GDPR) and California's Consumer Privacy Act (CCPA). To comply with such regulations, and to respect users' wish for privacy, website providers may prompt a user with a pop-up or banner notification asking for the user's consent to track the user's online behavior (e.g., through the use of cookies, beacons, etc.). When a user declines the use of cookies, for example, website will not utilize cookies or other tracking techniques for that particular user or instance. Because the cost of noncompliance can be high (e.g., fees, penalties, reputational harm), web site providers have strong incentives to ensure that user's choices with respect to privacy and tracking are respected.

### BRIEF DESCRIPTION OF THE DRAWINGS

Many aspects of the present disclosure can be better understood with reference to the following drawings.

FIG. 1 is a schematic block diagram of a computing device in which a system for evaluating consent management related to online content may operate, in accordance with embodiments of the present disclosure.

FIG. 2 is a schematic block diagram of a system for evaluating online advertisement content, in accordance with embodiments of the present disclosure.

FIG. 3 is a schematic diagram illustrating content distribution amongst various parties in an online environment, in accordance with embodiments of the present disclosure.

FIG. 4 is a schematic block diagram of a content monitor for generating synthetic-user profiles, in accordance with embodiments of the present technology.

FIG. 5 is a functional block diagram of a system for evaluating consent management related to online content, in accordance with embodiments of the present technology.

FIG. 6 is a flow diagram illustrating a process for evaluating consent management related to online content, in accordance with embodiments of the present technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

I. Overview

Many websites track user behavior using cookies, beacons, or other techniques. Such tracking is regulated in many jurisdictions, for example requiring a user to opt-in or otherwise provide consent to the use of such tracking. In many cases, a website provider partners with a third-party consent management platform (CMP) that manages the content of user privacy notifications and user responses. Because noncompliance with privacy regulations can result in significant fines, penalties, or public backlash, website providers have an incentive to ensure that the user's choices regarding privacy and tracking are respected. It can be difficult, however, to confirm that a user who has opted out of tracking is in fact not being tracked while on the website. In some cases, for example, a particular website can have several or even dozens of trackers (e.g., DoubleClick, AdSense, Facebook Audiences, etc.). Accordingly, there remains a need to evaluate consent management related to online content such that any noncompliant trackers can be identified and removed from the target website or modified such that they no longer track users who have expressed a wish to not be tracked.

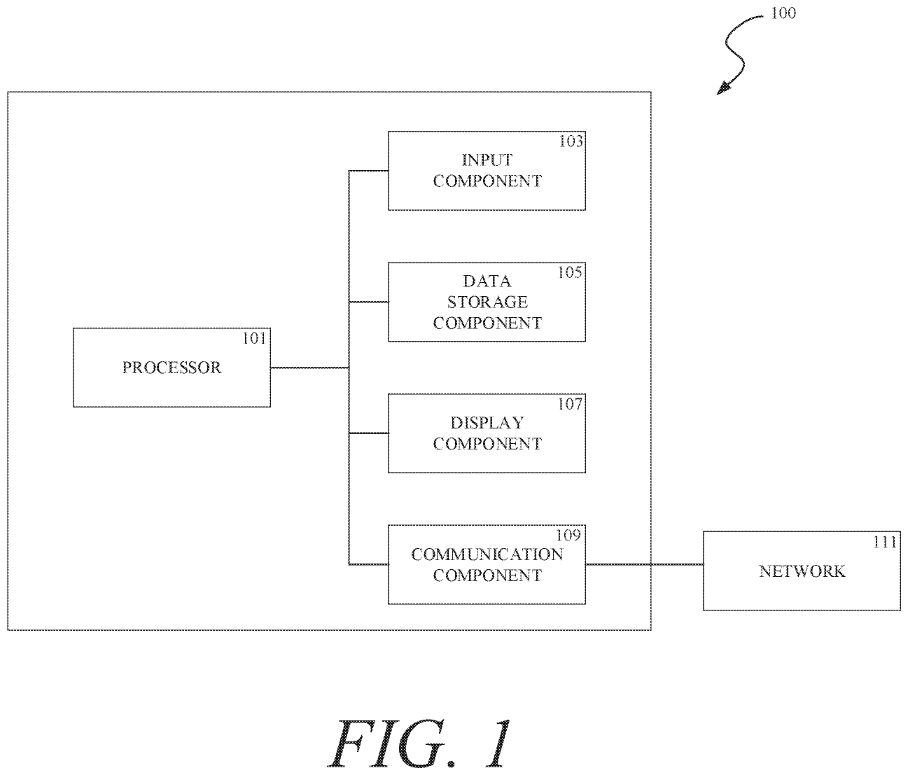

As described in more detail below, embodiments of the present technology can address these and other problems by generating one or more synthetic-user profiles that simulate real-world users. The synthetic-user profiles can be modified to have any desired consent status or properties. For example, first and second synthetic-user profiles can be generated that are identical or substantially similar (e.g., similar browser configuration, browsing history, etc.). With respect to a particular target website, such as www.Ford.com, The first synthetic-user profile can have a cookie or other property that indicates the user has not consented to tracking, while a second synthetic-user profile can have a cookie or other property that indicates the user has consented to tracking. By navigating these synthetic-user profiles to third-party websites and analyzing the data presented (particularly dynamic content such as dynamic advertisements), a system as disclosed herein can determine whether the user's consent statuses have in fact resulted in differential treatment with respect to tracking of user behavior. For example, if the www.Ford.com has properly managed the user consent, then one would expect the second synthetic-user profile to receive retargeted advertisements on third-party websites (either for Ford automobiles or for automobiles in general) at a significantly higher rate than the first synthetic-user profile. If both synthetic-user profiles receive significant retargeted advertisements (e.g., each being served ads for Ford F-150s on third-party sites), then it can be inferred that the first synthetic-user profile has been tracked at www.Ford.com, despite the cookie or other property indicating that the user has not consented to such tracking. By performing these and other similar analyses, for example including many different synthetic-user profiles and many different third-party websites, embodiments of the present technology can readily perform privacy audits for a target website, quickly determining whether the consent management for that particular website complies with applicable regulations and/or the company's own privacy policy. Specific details of several embodiments of the technology are described below with reference to FIGS. 1-6.

While some examples described herein may refer to functions performed by given actors such as “users,” and/or other entities, it should be understood that this is for purposes of explanation only. The claims should not be interpreted to require action by any such example actor unless explicitly required by the language of the claims themselves.

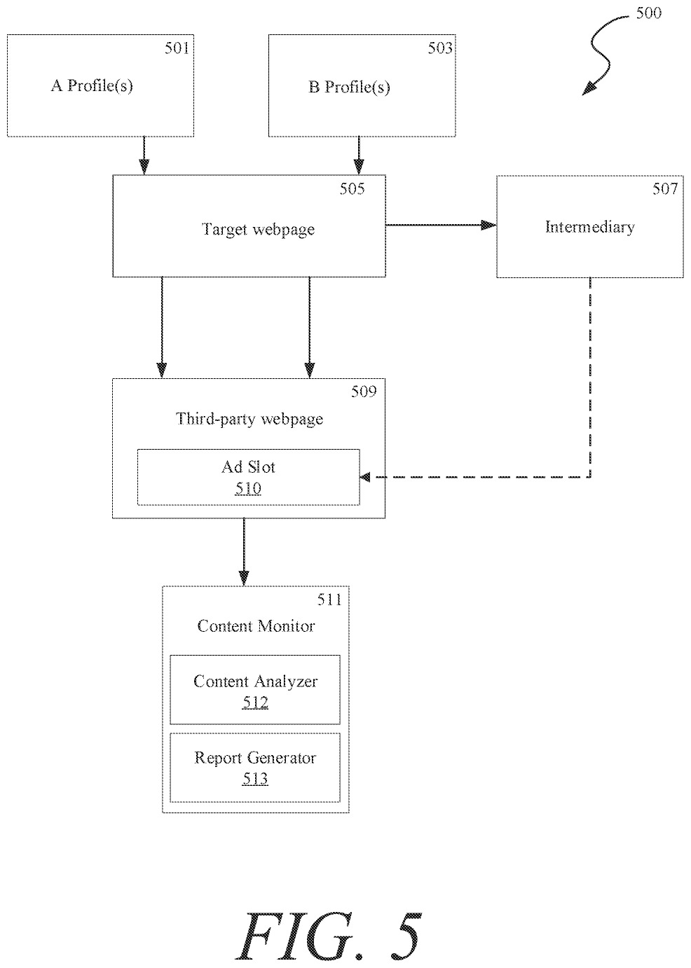

In the Figures, identical reference numbers identify generally similar, and/or identical, elements. To facilitate the discussion of any particular element, the most significant digit or digits of a reference number refers to the Figure in which that element is first introduced. For example, element 101 is first introduced and discussed with reference to FIG. 1, and element 503 is first introduced and discussed with reference to FIG. 5. Many of the details and other features shown in the Figures are merely illustrative of particular embodiments of the disclosed technology. Accordingly, other embodiments can have other details and features without departing from the spirit or scope of the disclosure. In addition, those of ordinary skill in the art will appreciate that further embodiments of the various disclosed technologies can be practiced without several of the details described below.

II. Suitable Operating Environment

FIG. 1 is a schematic block diagram of a computing device 100 in which a system for evaluating consent management related to online content may operate, in accordance with embodiments of the present disclosure. As shown in FIG. 1, the computing device 100 includes a processor 101, an input component 103, a data storage component 105, an output component 107, and a communication component 109. The processor 101 is configured to couple with and control other components in the computing device 100. The computing device 100 can communicate with other systems (e.g., Web servers or other devices) through the communication component 109 via a network 111. In some embodiments, the computing device 100 can communicate with additional devices (e.g., printers, tactile output devices, etc.) through the communication component 109. Network 111 can be any private or public network, such as the Internet, a corporate intranet, a wireless communication network, or a wired communication network.

The input component 103 is configured to receive an input (e.g., an instruction or a command) from a device user. The input component 103 can include a keyboard, a mouse, a touch pad, a touchscreen, a microphone, a joystick, a pen, a game pad, a scanner, a camera, and/or the like. The data storage component 105 can include any type of computer-readable media that can store data accessible to the processor 101. In some embodiments, the data storage component 105 can include random-access memories (RAMs), read-only memories (ROMs), flash memory cards, magnetic hard drives, optical disc drives, digital video discs (DVDs), cartridges, smart cards, etc.

The output component 107 is configured to output information to the device user. In some embodiments, the output component 107 can include one or more display (e.g., flat panel displays such as liquid crystal displays (LCDs), light emission diode (LED) displays, plasma display panels (PDPs), electro-luminescence displays (ELDs), vacuum fluorescence displays (VPDs), field emission displays (FEDs), organic light emission diode (OLED) displays, surface conduction electron emitter displays (SEDs), or carbon nano-tube (CNT) displays). In some embodiments, the output component 107 can include an audio transducer such as a speaker configured to output audible information to the device user.

A person of ordinary skill in the art will recognize that not all of the components of FIG. 1 are necessary to conduct embodiments of the present disclosure. For example, a computing device having the processor 101, data storage component 105, and communication component 109 may suffice.

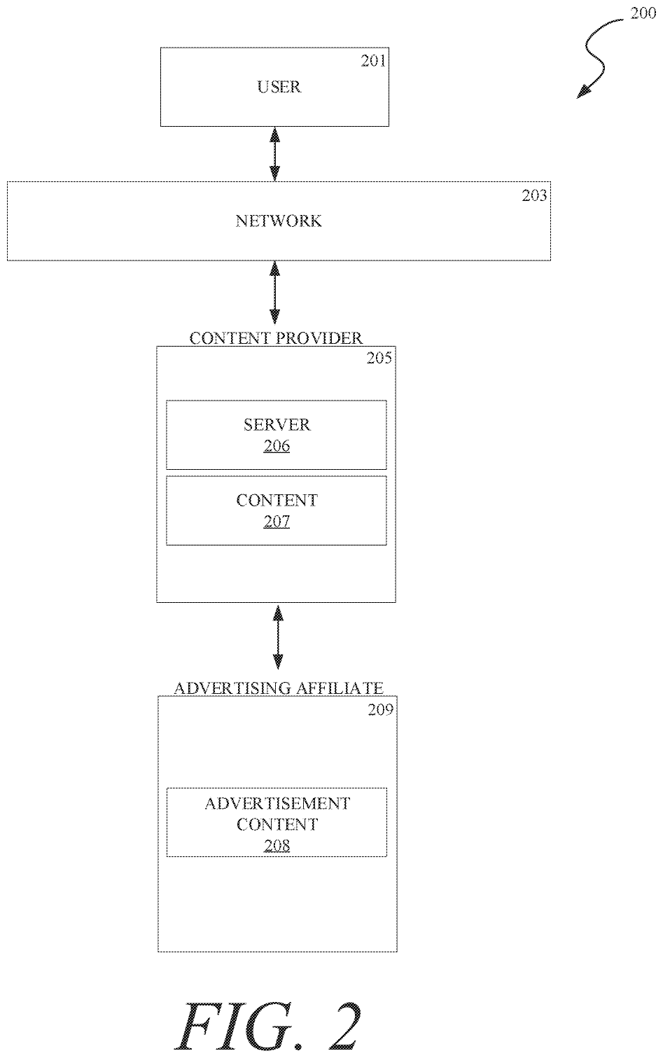

FIG. 2 is a schematic block diagram of a system 200 for monitoring online advertisement content, in accordance with embodiments of the present disclosure. As shown in FIG. 2, the system 200 includes a content provider 205, an advertising affiliate 209 in communication with the content provider 205, and a network 203 in direct or indirect communication with each of the content provider 205 and advertising affiliate 209. The content provider 205 can include a web server 206 for providing content 207 to a user or visitor 201 via the network 203. The content 207 can include static or dynamic webpages that utilize coding languages (e.g., HTML, PHP, Perl CGL, ASP, etc.) and that have advertisement content. The content 207 can be provided via the content provider 205 or the advertising affiliate 209, as discussed in more detail elsewhere herein. The user 201 can be associated with one or more computing devices, e.g., the device 100 (FIG. 1), that host user-specific data or information (e.g., cookies).

The advertising affiliate 209 can be configured to provide targeted or context-determined dynamic content (e.g., advertisement content) 210 in conjunction with other content provided by the content provider 205. The advertisement content 210 to be provided to the content provider 205 can be selected from a database of available advertisement content, which is commonly provided via various advertisers or content providers along with information regarding the target audience.

In operation, when a user 201 visits or requests to visit a webpage hosted on the server 206 of a content provider 205, the advertising affiliate 209 can determines the particular advertisement content 210 to be provided in conjunction with the other content of the webpage. In some embodiments, the advertisement content 210 provided for a particular user is based at least in part on a profile or browsing history of that user 201. For example, if the user previously visited a webpage of a first content provider, the first content provider may provide persistent data to be associated with that user (e.g., cookies stored by the user's browser), which may be utilized by the advertising affiliate such that the advertising affiliate 209 can target that user on the first content provider's behalf.

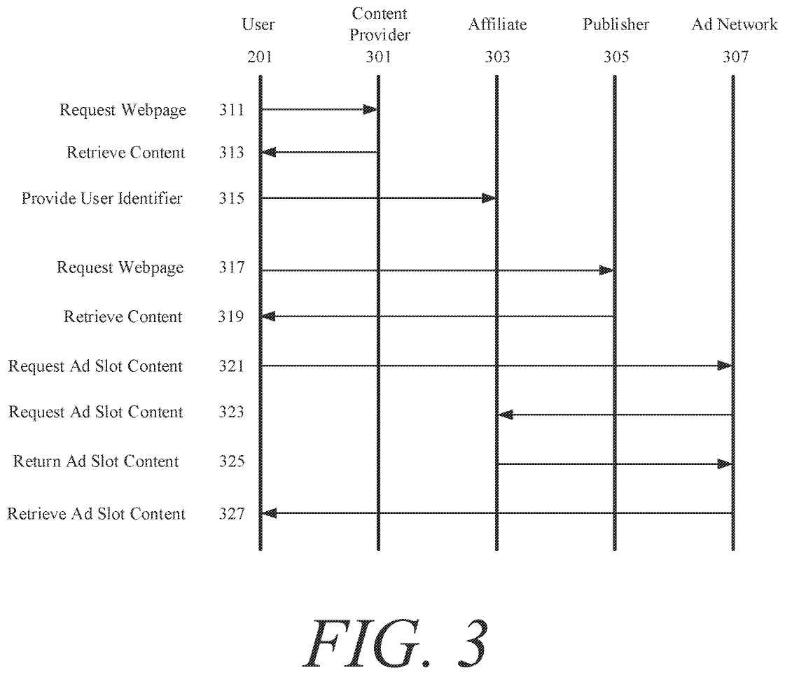

FIG. 3 is a schematic diagram illustrating content distribution amongst various parties in an online environment, in accordance with embodiments of the present disclosure. As shown in FIG. 3, the user 201 can initiate a request to a webpage of a content provider 301 (line 311), and in response the content provider 301, or server hosting the content provider's webpage, can provide content to the user (line 313) to enable assembly of a dynamic webpage. The content provider can correspond to the content provider 205 (FIG. 2) previously described, and/or any server or webpage affiliated with a party or company offering goods and services (e.g., an automotive or hospitality company). The content provided via line 313 can include non-advertisement content, and in some embodiments may only include non-advertisement content. Additionally or alternatively, the content provided via line 313 can include one or more cookies or other information to identify the user 201, and advertisement configuration protocol, e.g., for determining how and what advertisement content is displayed on the retrieved webpage from the content provider 301. After requesting the webpage via line 311, the cookie or other identifying information of the user 201 may be provided to and/or requested from an affiliate 303 (line 315). The cookie or other identifying information can include data corresponding to the user's previous visit to the content provider 301 which, as explained in detail elsewhere herein, may be later used by the affiliate 303 to retrieve advertisement content specifically for the user 201. The affiliate 303 can correspond to the advertising affiliate 209 (FIG. 2) previously described, and/or an external provider or intermediary, as explained in detail elsewhere herein (e.g., with reference to FIG. 5).

After or simultaneous to the cookie or other identifying information of the user 201 being provided to the affiliate 303 via line 315, the user 201 may initiate a request to a webpage of a publisher 305 (line 317). The publisher 305 can correspond to any webpage (e.g., a news or sports webpage) that has an advertisement slot to be filled with advertisement content. In response to the user's request via line 317, the publisher 305, or server hosting the publisher's webpage, provides content to the user 201 (line 319) to enable assembly of a dynamic webpage. After or simultaneous to requesting the webpage from the user 201 via line 317, the user 201 may also request advertisement content for the advertisement slot of the previously requested publisher's webpage (line 321). Such a request may be directed to an advertisement network 307. The advertisement network 307 may correspond to an intermediary (e.g., a different intermediary than the affiliate 303), as explained elsewhere herein. In response to receiving the request from the user 201, the advertisement network 307 may request advertisement content from the affiliate 303 (line 323), which in turn may return advertisement content (e.g., advertisement content 210; FIG. 2) to the advertisement network 307 (line 325). The advertisement content returned to the advertisement network 307 may be based on the cookie or other identifying information of the user provided to the affiliate 303 via line 315. As a result, and as explained in more detail elsewhere herein, the advertisement content returned to the advertisement network 307 may be content from the content provider 301 or content affiliated with the content provider's direct or indirect competitors. The advertisement content for the advertisement slot returned to the advertisement network 307 can be retrieved by the user 201 (line 327) and thereby fill the advertisement slot on the publisher's webpage.

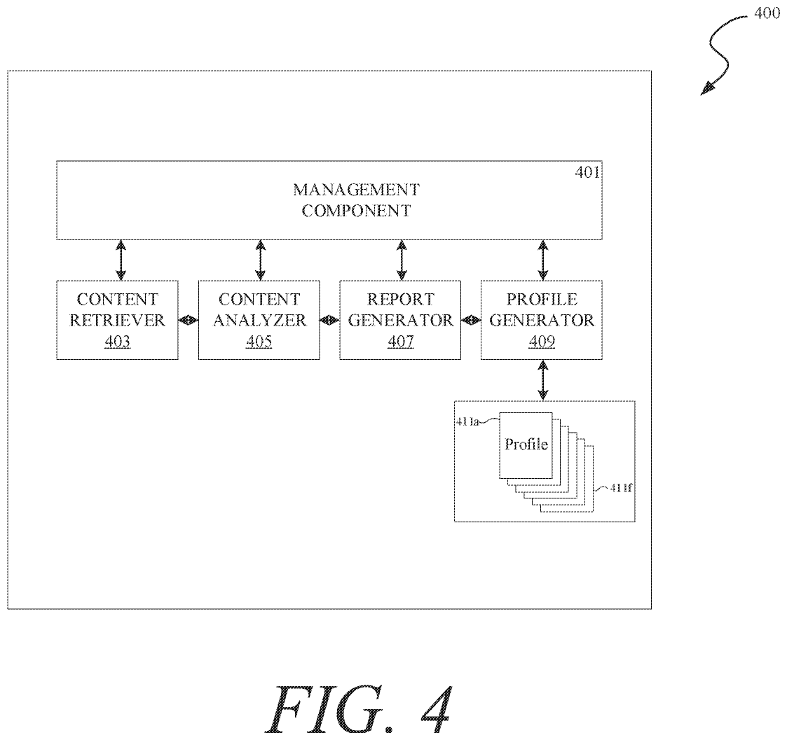

FIG. 4 is a schematic block diagram of a content monitor 400, in accordance with embodiments of the present technology. The content monitor 400 can be configured to evaluate online advertisement content, and/or manage a process for measuring the quality and/or performance of online advertisement content. As shown in FIG. 4, the content monitor 400 can include a management component 401, a content retriever 403, a content analyzer 405, a report generator 407, and a profile generator 409.

The management component 401 can be configured to facilitate inter-process cooperation and operation between the individual components of the content monitor 400. Additionally or alternatively, the management component 401 may include logic to schedule and/or marshal various events and tasks amongst the individual components. Each of the content retriever 403, content analyzer 405, report generator 407, and profile generator 409 can be in direct or indirect communication with one another and the management component 401. The content monitor 400 can be configured to communicate with disparate computing devices, e.g., over a local or wide area network. For example, the content monitor 400 can communicate with a remote content provider, e.g., as disclosed elsewhere herein.

The content retriever 403 can be configured to retrieve content from specified websites and/or webpages. The content retriever 403 can visit one or more webpages, e.g., on behalf of the content provider 205 (FIG. 2), for evaluating content (e.g., advertisement content provided by an advertising affiliate 209 (FIG. 2). For example, in some embodiments, the content retriever 403 may sample the content provider's web site to retrieve advertisement content therefrom. The sampling may occur by actually visiting the content provider's website, e.g., via a web browser that has a native profile or measurement tools, and/or by invoking profiles (e.g., synthetic profiles) to simulate visiting the content provider's website by an actual user. Any retrieved content from the content retriever 403 can be provided to the content analyzer 405.

The content analyzer 405 is configured to perform an analysis of the quality of at least a portion of the retrieved content, e.g., from the content retriever 403. For example, the content analyzer 405 can analyze the external content (e.g., the advertisement content) from the content provider's website that was provided from the advertising affiliate. As another example, the content analyzer 405 can analyze advertisement content or other resources (e.g., multimedia content) provided by the content provider itself. Various types of analyses can be performed on the retrieved content, which may be used to determine a quality score for the retrieved content. The quality score can correspond to, e.g., the appropriateness of the content for a particular user profile. That is, the quality score may serve as a measure of the effectiveness the content would have on an actual user having that particular user profile. Additionally, the quality score may be based on the following criteria:

1. CPU Time—A CPU time metric may be computed by producing an aggregate total (or other summary statistic) using measurements of the advertisement content. The measurements may be provided natively by the web browser, or determined by other code profiling mechanisms. The profiling mechanisms can include one or more of (i) the wall clock time of individual function calls comprising loads for the advertisement content, (ii) the thread clock time of individual function calls comprising the loads, or (iii) the longest non-yielding call, with respect to either wall clock time or thread clock time.

2. Network Transfer Data—A network transfer data metric may be computed by producing an aggregate total (or other summary statistic) of the data transferred over the network. Additionally, the network transfer data metric can also be computer by measuring the distribution of the number of (i) bytes in a network request or response, (ii) resource requests made, (iii) resource requests fetched from the browser cache instead of the network, or (iv) resource requests resulting in errors (either in aggregate, or by error code), may be used as an additional metric.

3. Animation Load—An animation load metric may be computed based on the total number of compositing or paint events either as a direct measurement or as a proxy for CPU time. This number can be based on one or both of high-frequency repaint events and CSS animation frames, occurring either in the browser's main thread or in a separate compositing or rendering thread.

4. Tracker Load—A tracker load metric may be computed based on the number of “tracking pixels” or likely tracking scripts. In one implementation, this value may be produced by counting the number of resource requests determined to be likely trackers. Identification of trackers may be rule-based or statistical, and may be performed using either individual, or weighted combinations of rules. Illustrative rules that may be implemented may be based on mime types or file extensions identifying an asset as an image, missing mime types, plain text responses, small response payload sizes, response payload sizes matching exactly “known values” for tracking pixels, or the like.

5. Rich Media—A rich media score may be quantified to estimate the presence of rich media. This score may be determined via (i) static analysis of the advertisement content, (ii) inspecting the file type or size of downloaded assets, and/or (iii) inspecting measurements.

6. Secured Resource Requests—A secured resource metric may be quantified based on the number or proportion of secured requests (e.g., SSL-enabled requests). Non-encrypted advertisement resources are not eligible for HTTP2 and may actually be a detriment to performance.

7. Malware Detection—A malware scoring criterion may be computed based on an analysis of the analyzed portion for the presence of malicious code, such as “malware,” spyware,” “adware,” or the like.

Based on at least some of the above-described criteria, the content analyzer 405 can generate the quality score that represents a quality value for the content. In some embodiments, the quality score can be a plurality of individual scores, a combination of individual scores of one or more of the foregoing evaluations, a weighted (e.g., equally weighted or non-equally weighted) average of two or more of the foregoing evaluations, or any combination thereof. Additionally or alternatively, the process for generating the quality score can utilize a rules-based engine, a statistical method, a predictive model, or a combination thereof.

Once the quality score for a particular piece of advertisement content has been generated, the quality score can be communicated to the report generator 407. As previously described, the report generator 407 can generate a response based on the quality score and criteria provided by the content provider and/or retrieved via the content retriever 403. The response may take a number of different forms. In some embodiments the report generator 407 formulates a report based on the “quality” of advertisement content served in conjunction with the content provider's content. For example, the report generator 407 may compare the quality score for one or more pieces of advertisement content against a given criteria. Any advertisement content which does not satisfy (e.g., is above or below) the given criteria are reported as being “bad.” Failing the given criteria may be the result of a single metric falling below said criteria, a plurality of metrics falling below multiple criteria, or one or more metrics falling below an average or weighted average of the criteria.

The report generator 407 is configured to generate one or more reports based on the evaluation of the advertisement content. For the advertisement content identified as bad, the report generator 407 may issue a corresponding notification either to the content provider 205 (FIG. 2), the advertising affiliate 209 (FIG. 2), another third party, or a combination thereof. The notification may take the form of an automated request to prevent any “bad” advertisement content from being served in conjunction with the content provider's website. In one specific implementation, such a request may take the form of an automated e-mail, a reporting webpage, an API call to the advertising affiliate, or the like. In some embodiments, a report may only be generated if the evaluated quality is above or below a predetermined threshold.

The profile generator 409 is configured to create and manage a plurality of synthetic-user profiles 411a-f (collectively referred to herein as “profiles 411”). Each of the profiles 411 can represent a fabricated browsing history of an imaginary user. In such embodiments, each of the profiles 411 is configured to simulate the browsing habits of a real person by performing a multiplicity of activities, e.g., browsing or searching the Internet. In doing so, a user having a particular browsing history, device configuration, browser software, and other associated data, can be generated and used to evaluate content management, as described elsewhere herein.

In operation, the content monitor 400 can perform multiple browsing sessions by visiting numerous websites. The profile generator 409 is configured to access each of the websites, e.g., using browsing software that accumulates user-specific data from each website. For example, the profile generator 409 may visit a first website including content pertaining to the automotive industry. By visiting this first website, the profile generator 409 accumulates the cookies and other user-specific data associated with the first website. Additionally, the profile generator 409 may visit a second website including content pertaining to a political party. By visiting this second website, the profile generator 409 accumulates the cookies and other user-specific data associated with the second website. The profile generator 409 can repeat this behavior, visiting websites. The profile generator 409 can repeat this behavior for numerous other websites having different and/or varying characteristics. As a result of visiting the websites, the profile generator 409 can accumulate user-specific data that corresponds to a particular browsing history or pattern, and that is stored as one of the profiles 411.

The profile generator 409 may repeat the foregoing operations to generate different user profiles. In some embodiments, the visited websites may be selected via a variety of methods, including random sampling of top websites. In addition to or in lieu of the foregoing, the visited websites may be selected to simulate the expected browsing habits of a target demographic. For example, the content monitor 400 may be tasked with creating one user profile simulating the browsing characteristics of a mature or elder adult, and another user profile simulating the browsing characteristics of a young adult. In such embodiments, different browsing criteria may be specified to generate different profiles. For example, the young adult may be more likely to visit a social network website and a multimedia website, whereas the mature adult may be more interested in an industry news website and a political blog. Accordingly, different profiles 411 may be generated by specifying different browsing patterns which the profile generator 409 may execute. In addition to varying the browsing history of various synthetic user-profiles, the profile generator 409 may vary other aspects of the profiles 411, such as device configuration (e.g., device ID), browser software (e.g., Chrome®, Internet Explorer®), geo-location data, time zone data, etc.

III. Example Systems and Methods for Evaluating Consent Management Related to Online Content

As previously described, websites are often required to obtain user consent before tracking the user's behavior (e.g., through the use of cookies, beacons, or other tracking techniques). Additionally, it can be difficult to verify that a particular website has honored the user's selection with respect to tracking. In some embodiments, the present technology provides systems and methods for evaluating consent management to verify whether, when a user opts out of tracking by that particular website, the user is indeed not being tracked. In some instances, this verification can include utilizing a synthetic-user profile to navigate to the target website and indicate an opt-out or do-not-track consent status. While on the target website, the website data can be scraped and analyzed to determine the presence of any trackers and those trackers (or a third-party content management platform (CMP)) can be queried regarding whether they have registered an opt-out or do-not-track status for that synthetic-user profile. Additionally or alternatively, the synthetic-user profile can be navigated to one or more third-party websites. The data presented on those third-party websites (e.g., dynamic or programmatic advertisements) can be assessed to determine whether the data indicates tracking by the synthetic-user profile at the target website.

FIG. 5 is a functional block diagram of a system 500 for evaluating consent management relating to online content, in accordance with embodiments of the present technology. In the example shown in FIG. 5, the system 500 includes one or more A profiles 501 and B profiles 505. In alternative implementations, the system can include only A profiles (e.g., the techniques described herein need not include A/B testing to compare two groups of user profiles). With respect to the example shown in FIG. 5, Each A profile 501 and B profile 503 can generally correspond to a synthetic-user profile, as discussed elsewhere herein, configured to emulate a target audience member (e.g., the user 201; FIG. 2) of a content provider (e.g., the content provider 205; FIG. 2). For example, the A profile may have a simulated browsing history that is pseudo-random and/or that represents a particular demographic (e.g., an adolescent adult). In various embodiments, the A and B profiles can be identical or substantially identical except for the consent status or consent properties of the two profiles. For example, the A profiles 501 can include an indication (e.g., a cookie) that the user has not consented to being tracked at the target website, while the B profiles 503 can include an indication (e.g., a cookie) that the user has consented to being tracked at the target website. Although certain examples are described below with respect to single A and B profiles, in certain embodiments there may be several (e.g., dozens or more) of A and B profiles, each having different user characteristics (e.g., browser type, browsing history, demographic characteristics, etc.).

As shown in FIG. 5, the A profiles 501 and B profiles 503 are provided (e.g., navigated to or otherwise exposed) to one or more target webpages 505 (referred to hereinafter as target webpage 505. For purposes of this disclosure, the owner of the target webpage 505 is referred to as the original content provider. The target webpage 505 may be hosted by an affiliated server (e.g., server A) and/or owned by a company (e.g., company A) that generally operates within a particular category (e.g., auto, travel, healthcare, hospitality, insurance, telecommunications, food, beverage, retail, financial, etc.) of goods or services. As an example, for the auto category, the target webpage 505 can include one or more webpages associated with Ford®. While on the target webpage, the A profiles ought not to be tracked, because the A profiles have a consent status or property indicating that they have not provided the required consent. In contrast, the B profiles are expected to be tracked, because the B profiles have a consent status or property indicating that they have consented to tracking by the site that includes the webpage 505.

In some embodiments, the A profile's browsing history only includes a single target webpage 505 within the category of the original content provider. For example, for the auto category, the A profile may include browsing history for only a webpage associated with Ford® and no other browsing history associated with auto webpages. In some embodiments, limiting exposure of the A and/or B profiles to a single target webpage 505 in a particular category can help determine (i) whether the user's consent selection has been honored and, (ii) if the user is being tracked without consent, the source of the tracking.

In various embodiments, the data regarding the A profiles (e.g., those consenting to user-tracking) may be shared by the target website 505 with one or more intermediaries 507 (referred to hereinafter as “intermediary 507”). As explained elsewhere herein, in practice the data is shared with the intermediary 507 to enable the intermediary to target the A profile with advertisement content of the original content provider. The intermediary can include an advertisement agency (e.g., an advertisement trading desk), advertiser advertisement server, data management platform, customer data platform, demand side partner (DSP), advertisement exchange, data exchange, advertisement network, supply side platform, publisher advertisement server, or other parties that facilitate exchange of content from content providers to third-party websites. In some embodiments, the intermediary 507 has a contractual relationship with the original content provider associated with the target webpage 505, such that the intermediary 507 has an obligation to target users with advertisement content of the original content provider. In some embodiments, there may be a chain of intermediaries between the original content provider and the third-party webpage on which the advertisement is served.

After providing the data to the intermediary 507, the A profile 501 and B profile 503 are then provided (e.g., navigated, directed, or exposed) to one or more third-party webpages 509 (referred to hereinafter as “third-party webpage 509”) having at least one advertisement slot 510 thereon. The third-party webpage 509 can be any webpage not (i) controlled by the original content provider of the target webpage 505; (ii) hosted by the same web server (i.e., server A) as the target webpage 505, and/or (iii) in the same category of the target webpage 505. For example, if the target webpage 505 is in the auto category, the third-party webpage 509 the A and B profiles are exposed to is not in the auto category. Additionally, the third-party webpage does not include the target webpage 505. In some embodiments, providing the A and B profiles to the third-party webpage 509 can occur repeatedly. For example, the A and B profiles can be exposed to the third-party webpage 509 for a certain duration (e.g., 1 hour, 2 hours, 3 hours, 4 hours, 5 hours, 6 hours, 12 hours, 1 day, 2 days, 3 days, 4 days, 1 week, 2 weeks, or any time therebetween) and/or at a particular frequency (e.g., every 1 hour, 2 hours, 3 hours, 4 hours, 5 hours, 6 hours, 12 hours, 1 days, etc.).

As described elsewhere herein (e.g., with reference to FIG. 3), the third-party webpage 509 typically utilizes one or more intermediaries to sell rights to the advertisement slot 510 for each user visit to the third-party webpage 509. As also described elsewhere herein, these one or more intermediaries will be provided the first party data associated with the A and/or B profiles and attempt to provide advertisement content in the advertisement slot 510 based on the profiles (i.e., a synthetic user). Additionally, the one or more intermediaries will attempt to maximize revenue for the advertisement slot 510 by offering, selling, or providing the advertisement slot 510 to the content provider most interested in targeting the user with its advertisement content.

Because only the first-party data of the B profile (the profile that consented to user tracking) was provided to the intermediary 507, and the first-party data of the A profile (which did not consent to user tracking) was not, the intermediary 507 may provide to the advertisement slot 510 advertisement content of the original content provider associated with the target webpage 505 to the B profile but not to the A profile.

The above-described operations of FIG. 5 generally correspond to a single A and single B profile being provided to the intermediary 507 and the third-party webpage 509. However, the above-described operations can be conducted multiple times using a plurality of A and/or B profiles. That is, different B profiles that each have first party data corresponding to the target webpage 505 can be generated and provided to the intermediary 507. The A and B profiles can then be exposed to a variety of third-party webpages 509 having advertisement slots 510 thereon.

Additionally or alternatively to the above-described operations of FIG. 5, in some embodiments the A profile 501 may likewise be exposed or directed to one or more third-party webpages 509, e.g., via a parallel process. At the third-party webpage 509, the advertisement slot 510 may be filled by advertisement content displayed to the A profile 501 or the synthetic users associated therewith. Because the A profile 501 has not been exposed to the target webpage 505 (in contrast to the B profiles), they may serve as a baseline for comparison with respect to the particular advertisement content provided via the advertisement slot 510 of the third-party webpage 509. For example, if the A and B profiles 501, 503 are shown substantially similar or identical advertisements via the third-party webpage 509 (e.g., both being served targeted advertisements in the same category as the target webpage), then it is likely that the A profile's do-not-track consent status has not been respected by one or more trackers associated with the target webpage. In contrast, if the advertisement content provided to the A and B profiles 501, 503 differ (e.g., with the B profile being served targeted ads in the same content category as the target webpage 505, but the A profile not being served such ads), then the difference may indicate that the varying consent status of the A and B profiles has been respected by any trackers associated with the target webpage 505.

In some embodiments, the B profile 503 may not be directed to the third-party webpage 509, and instead analysis of the advertisement content served to the A profile 501 may itself suffice to detect that the A profile 501 has been tracked in violation of its consent status. That is, consent management can be evaluated via the A profile 503 without considering the B profile 501.

Data associated with the advertisement content provided via the third-party webpage 509 is retrieved by or provided to a content monitor 511. The content monitor 511 can correspond to the content monitor 400 previously described, and may include similar or identical components and/or features. As shown in FIG. 5, the content monitor 511 includes a content analyzer 512 and a report generator 513. The content analyzer 512 can include similar or identical features to those of content analyzer 405 (FIG. 4), and the report generator 513 can include similar or identical features to those of the report generator 407 (FIG. 4). The content analyzer 512 is configured to analyze the retrieved data of the third-party webpage 509, including the advertisement content that was provided thereon to each of the A profiles 501 and B profiles 503. For example, the content analyzer 512 can (i) categorize the advertisement content into one of the categories of goods or services previously described, and/or (ii) determine whether the advertisement content corresponds to the original content provider of the target webpage 505. Additionally, in some embodiments the content analyzer 512 can determine whether the advertisement content corresponds to a different content provider (i.e., not the original content provider), including one in the same category of goods or services (e.g., the auto category). That is, the content analyzer 512 can determine whether the advertisement content provided to the A profile when visiting the third-party webpage 509 corresponds to competitors of the original content provider or other content providers interested in the A profile's interaction with the target webpage 505.

As noted previously, in some embodiments both the A profile 501 and B profile 503 may be exposed to the third-party webpage 509. The content monitor 511 can collect data regarding which advertisement content was displayed to which profiles, and the content analyzer 512 may analyze the collected and/or aggregate data to determine whether any similarities or discrepancies exist and if they indicate violation of privacy policies (e.g., tracking users against their consent). For example, the prevalence of certain advertisement content presented to the A profile 501 may provide a baseline against which the B profile 503 is compared or vice versa. If, compared to the A profile 501, the B profile 503 is shown substantially different advertisement content, then the discrepancy may be due to the different consent statuses, as would be appropriate. This may be particularly true if the B profile 503 is served an increased number of advertisement content in one or more categories associated with the target webpage 505.

The report generator 513 is configured to generate one or more reports based on analysis or output signals from the content analyzer 512 and/or the retrieved data or content of the third-party webpage 509. For example, as previously described, if the content analyzer 512 determines that the user is being tracked in contrast to a do-not-track consent indication, the report generator 513 may automatically generate a report or indication (e.g., an email, text message, phone call, etc.) to be sent to one or more recipients indicating such.

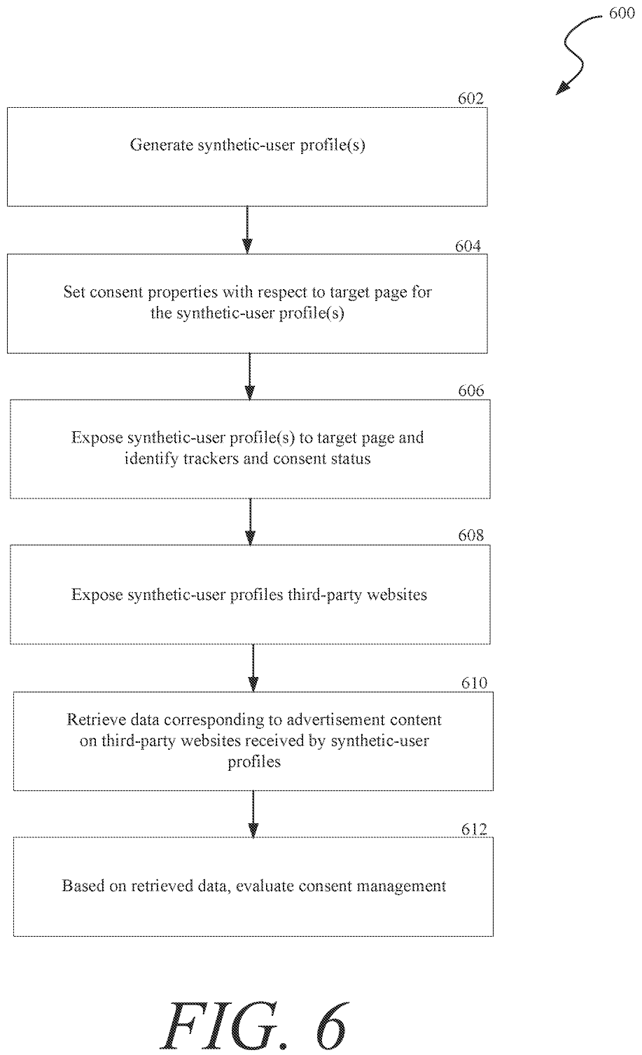

FIG. 6 is a flow diagram illustrating a process 600 for evaluating consent management in accordance with embodiments of the present technology. As shown in FIG. 6, the process 600 includes generating synthetic-user profiles (process portion 602). As explained elsewhere herein, each of the synthetic-user profiles can emulate a user or target audience member that visits the website of a content provider. In process portion 604, consent properties are set for the synthetic-user profiles with respect to a target page. For example, a first group of synthetic-user profiles can be configured with a cookie or other indication that the user has consented to tracking, and a second group of synthetic-user profiles can be configured to indicate that the user has not consented to tracking. The process 600 further includes providing or exposing the synthetic-user profiles to one or more target pages (process portion 606). Additionally, the method can include identifying one or more trackers that are active on the target page. Moreover, a consent status for each particular synthetic-user profile can be assessed for any identified tracker. For example, the target page can be evaluated to identify an Amazon Ad System tracker that is active on the page. Using the different synthetic-user profiles, the method can include determining whether Amazon Ad System recognizes or indicates an opt-out (e.g., do-not-track) status where appropriate (e.g., for the synthetic-user profiles that have opted out of tracking). If a certain tracker does not indicate or recognize an opt-out status for a synthetic-user profile, that tracker can be flagged as potentially violating the privacy policy associated with the target page.

The process 600 further includes providing or exposing the category profiles to third-party websites having advertisements slots (process portion 608). The third-party websites can include websites (i) controlled by an entity other than the entity controlling the predetermined website; (ii) hosted by a different web server than that of the predetermined website, and/or (iii) other than the predetermined website or websites corresponding to the same goods or services of the predetermined website's content provider (i.e., the original content provider). Accordingly, the third-party websites may or may not be in the category associated with the predetermined website's content provider. In some embodiments, providing or exposing the profiles to the third-party websites can occur repeatedly. For example, the category profiles can be exposed to the third-party websites for a certain duration (e.g., 1 hour, 2 hours, 3 hours, 4 hours, 5 hours, 6 hours, 12 hours, 1 day, 2 days, 3 days, 4 days, 1 week, or any time therebetween) and/or at a particular frequency (e.g., every 1 hour, 2 hours, 3 hours, 4 hours, 5 hours, 6 hours, 12 hours, 1 days, etc.).

The process 600 further includes retrieving data corresponding to advertisement content on the third-party websites that were provided to the category profiles (process portion 610). The retrieved data can include details on the advertisement content, including (i) the category of goods or services that the advertisement contents corresponds to, (ii) the content provider of the advertisement content, and/or (iii) the intermediary that supplied the advertisement content. The data can correspond to cookies, web-beacons, user-agent strings, referrer headers, combinations thereof, or other metadata associated with and extractable via the third-party websites.

The process 600 further includes evaluating consent management, based on the retrieved data (process portion 612). For example, if a synthetic-user profile that has opted out of tracking has nonetheless received targeted advertisements associated with the target page (e.g., from the same company or from other companies within a particular content category), then that synthetic-user profile was likely tracked by the target webpage in contradiction to the user's expressed lack of consent. In some embodiments, the targeted advertisements presented to various synthetic-user profiles having different consent status (e.g., some opting in, others opting out) can be compared and evaluated to determine whether the consent management system of the target webpage has performed appropriately.

An advantage of embodiments of the present technology is that website operators can determine and prove whether trackers on their website are or are not tracking users who opt out of tracking. As described elsewhere herein, website operators have previously been unable to definitively determine whether consent management systems were working properly because the platform to audit such consent management did not exist. Embodiments of the present technology address these and other issues.

### CONCLUSION

Although many of the embodiments are described above with respect to systems, devices, and methods for evaluating consent management, the technology is applicable to other applications and/or other approaches as well. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-6.

The above detailed descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A method for evaluating consent management related to online content, comprising:
generating a plurality of synthetic-user profiles including a first group and a second group;
establishing, for the first group, a first consent status with respect to a target website;
establishing, for the second group, a second consent with respect to the target website;
exposing the synthetic-user profiles to third-party websites such that dynamic content of the third-party websites are received by the first and second groups of the synthetic-user profiles;
retrieving data corresponding to the dynamic content of the third-party websites; and
based on the retrieved data, evaluating consent management with respect to the target website.

2. The method of claim 1, wherein the first consent status comprises an opt-in status with respect to one or more trackers, and second consent status comprises an opt-out status with respect to the one or more trackers.

3. The method of claim 1, wherein the first consent status comprises a cookie indicating an opt-in status with respect to user tracking, and the second consent status comprises a cookie indicating an opt-out status with respect to user tracking.

4. The method of claim 1, wherein (i) the dynamic content of the third-party websites received by the first group comprises first dynamic content, (ii) the dynamic content of the third-party websites received by the second group comprises second dynamic content, and evaluating consent management comprises comparing the first dynamic content and the second dynamic content.

5. The method of claim 4, wherein a higher rate of retargeted advertisements in the first dynamic content indicates tracking by the target website in violation of user consent.

6. The method of claim 1, wherein the synthetic-user profiles have profile characteristics, and wherein the first and second groups have similar or identical profile characteristics except for the consent statuses with respect to the target website.

7. The method of claim 1, wherein:
the third-party websites include internal content hosted by a first web server,
the dynamic content of the third-party websites received by the first group comprises first dynamic content,
the dynamic content of the third-party websites received by the second group comprises second dynamic content,
the first and second dynamic content of the third-party websites are hosted by a second web server different than the first web server, and
the first and second dynamic content of the third-party websites are based on individual synthetic-user profiles.

8. A tangible, non-transitory computer-readable medium storing instructions that, when executed by one or more processors of a computing system cause the system to perform a method comprising the method of claim 1.

9. A method for evaluating consent management related to online content, comprising:
generating a synthetic-user profile including a consent property indicating an opt-out status with respect to tracking user behavior for one or more target websites;
exposing the synthetic-user profile to one or more third-party websites such that dynamic content of the third-party websites is received by the synthetic-user profile;
retrieving data corresponding to the dynamic content of the one or more third-party websites; and
based on the retrieved data, evaluating consent management related to the target website.

10. The method of claim 9, further comprising identifying at least one tracker associated with the target website(s).

11. The method of claim 10, further comprising identifying a tracking-consent status for the synthetic-user profiles as reported by the at least one tracker.

12. A tangible, non-transitory computer-readable medium storing instructions that, when executed by one or more processors of a computing system cause the system to perform a method comprising the method of claim 9.
